(19) United States
(12) Patent Application Publication
(10) Pub. No.: US 2020/0259354 A1
(43) Pub. Date: Aug. 13, 2020

(54) CHARGING AND DISCHARGING CONTROL DEVICE FOR BATTERY PACK AND CHARGING AND DISCHARGING CONTROL METHOD FOR BATTERY PACK

(71) Applicant: TOYOTA JIDOSHA KABUSHIKI KAISHA, Toyota-shi (JP)

(72) Inventors: Yoshihiro UCHIDA, Nagakute-shi (JP); Kiyohito MACHIDA, Toyota-shi (JP); Yuki MORIYA, Okazaki-shi (JP); Nobuyuki TANAKA, Toyota-shi (JP); Kazuki KUBO, Toyota-shi (JP); Masaki UCHIYAMA, Obu-shi (JP)

(73) Assignee: TOYOTA JIDOSHA KABUSHIKI KAISHA, Toyota-shi (JP)

(21) Appl. No.: 16/724,546

(22) Filed: Dec. 23, 2019

(30) Foreign Application Priority Data
Feb. 7, 2019 (JP) 2019-020569

(51) Int. Cl. H02J 7/00

(52) U.S. Cl. CPC H02J 7/00714; H02J 7/0047; H02J 7/0013

(57) ABSTRACT

An ECU performs a process routine including a step of acquiring a voltage, a current, and a battery temperature, a step of estimating an SOC, a step of performing a parallel gain calculating process, a step of performing an IWin calculating process, a step of performing DWin/DWout calculating process, a step of performing an NWin/NWout calculating process, and a step of setting Win and Wout.

### INCORPORATION BY REFERENCE

The disclosure of Japanese Patent Application No. 2019-020569 filed on Feb. 7, 2019 including the specification, drawings and abstract is incorporated herein by reference in its entirety.

### BACKGROUND

### 1. Technical Field

The present disclosure relates to charging and discharging control for a battery pack including a plurality of batteries which are connected in parallel.

### 2. Description of Related Art

In the related art, a technique of protecting a battery pack in which a plurality of batteries is connected in parallel is known. For example, Japanese Patent Application Publication No. 2002-142370 (JP 2002-142370 A) discloses a technique of protecting a battery pack by cutting off a group of batteries in series from a parallel circuit in which groups of batteries in series are connected in parallel when a voltage of at least one group of batteries in series is different from a voltage of the other groups of batteries in series in the parallel circuit.

### SUMMARY

Protection of a battery pack may be achieved by performing charging and discharging control within a range in which a load on the battery pack is not excessive in addition to by detecting a part in which an abnormality occurs and cutting off the part in which an abnormality has occurred. However, particularly, in a battery pack in which a plurality of batteries is connected in parallel, the deviation of currents flowing in the batteries may be greater than that in a battery pack in which a plurality of batteries is connected in series. Accordingly, even when charging and discharging are controlled in the same way as in the battery pack in which a plurality of batteries is connected in series, a larger current than expected may flow in any battery out of the plurality of batteries and thus the battery pack may not be appropriately protected.

The present disclosure provides a charging and discharging control device for a battery pack and a charging and discharging control method of a battery pack that can appropriately protect a battery pack including a plurality of batteries which is connected in parallel.

According to an aspect of the present disclosure, there is provided a charging and discharging control device that controls charging and discharging of a battery pack including a plurality of battery elements which is connected in parallel. The charging and discharging control device for a battery pack includes: an estimation unit configured to estimate a current ratio of an average value of currents flowing in the plurality of battery elements to a maximum current with a largest magnitude out of the currents flowing in the plurality of battery elements based on a temperature deviation between the plurality of battery elements which are connected in parallel; a setting unit configured to set at least one of a charging power limit value and a discharging power limit value of the battery pack using the estimated current ratio; and a control unit configured to control charging and discharging of the battery pack such that the set limit value is not exceeded.

According to this configuration, the charging power limit value and the discharging power limit value can be set in consideration of the maximum current out of currents flowing in the plurality of battery elements which is connected in parallel. Accordingly, by controlling charging and discharging of the battery pack such that the set limit value is not exceeded, it is possible to curb occurrence of abnormalities in the battery pack and to appropriately protect the battery pack.

In an embodiment, each battery element may include a lithium-ion secondary battery. The setting unit may be configured to set an upper limit value of a charging current at which metallic lithium is not extracted in a negative electrode of at least one battery element out of the plurality of battery elements using the current ratio at the time of charging of the battery pack and to set the charging power limit value such that the magnitude of a current flowing in the battery element does not exceed the set upper limit value.

According to this configuration, since the upper limit value of the charging current is set using the current ratio, the charging power limit value can be set such that the magnitude of the current flowing in each battery element does not exceed the upper limit value. Accordingly, it is possible to prevent metallic lithium from being extracted in the negative electrode of the battery element.

In another embodiment, each battery element may include a lithium-ion secondary battery. The setting unit may be configured to calculate a charging/discharging intensity of at least one battery element out of the plurality of battery elements and a degree of deterioration based on a bias of a salt concentration between positive and negative electrodes of the battery element using the current ratio and to set at least one of the charging power limit value and the discharging power limit value using at least one of the calculated charging/discharging intensity and the calculated degree of deterioration.

According to this configuration, since the charging/discharging intensity and the degree of deterioration are calculated using the current ratio, an appropriate limit value can be set based on the charging/discharging intensity or the degree of deterioration. Accordingly, it is possible to curb so-called high-rate deterioration.

According to another aspect of the disclosure, there is provided a charging and discharging control device that controls charging and discharging of a battery pack in which a plurality of parallel battery blocks including a plurality of battery elements which is connected in parallel is connected in series. The charging and discharging control device for a battery pack includes: an estimation unit configured to estimate a current ratio of an average value of currents flowing in the plurality of battery elements to a maximum current with a largest magnitude out of the currents flowing in the plurality of battery elements based on a temperature deviation between the plurality of battery elements which is connected in parallel and a resistance ratio between a first combined resistance value of an internal resistor of a first block out of the plurality of parallel battery blocks and a second combined resistance value of an internal resistor of a second block; a setting unit configured to set at least one of a charging power limit value and a discharging power limit value of the battery pack using the estimated current ratio; and a control unit configured to control charging and discharging of the battery pack such that the set limit value is not exceeded.

According to this configuration, the charging power limit value and the discharging power limit value can be set in consideration of the maximum current out of currents flowing in the plurality of battery elements which is connected in parallel.

Accordingly, by controlling charging and discharging of the battery pack such that the set limit value is not exceeded, it is possible to curb occurrence of abnormalities in the battery pack and to appropriately protect the battery pack.

In an embodiment, the setting unit may be configured to calculate a mean square value of a current flowing in the battery pack using the estimated current ratio, to set an upper limit value of a temperature of the battery pack using the calculated mean square value, and to set at least one of the charging power limit value and the discharging power limit value such that the temperature of the battery pack does not exceed the upper limit value.

According to this configuration, a value based on a deviation of the mean square value of the currents correlated with an amount of heat emitted can be calculated with high accuracy. Accordingly, by setting the charging power limit value or the discharging power limit value such that the temperature of the battery pack does not exceed the upper limit value which is set using the mean square value, it is possible to curb overheating of the battery pack and to appropriately protect the battery pack.

In another embodiment, the charging and discharging control device for a battery pack may further include a determination unit configured to calculate a mean square value of a current flowing in the battery pack using the estimated current ratio and to determine that the battery pack is overheated when the calculated mean square value is greater than a threshold value.

According to this configuration, a value based on a deviation of the mean square value of the currents correlated with an amount of heat emitted can be calculated with high accuracy. Accordingly, it is possible to accurately determine whether the battery pack is overheated.

According to still another aspect of the present disclosure, there is provided a charging and discharging control method of controlling charging and discharging of a battery pack including a plurality of battery elements which is connected in parallel. The charging and discharging control method includes: estimating a current ratio of an average value of currents flowing in the plurality of battery elements to a maximum current with a largest magnitude out of the currents flowing in the plurality of battery elements based on a temperature deviation between the plurality of battery elements which are connected in parallel; setting at least one of a charging power limit value and a discharging power limit value of the battery pack using the estimated current ratio; and controlling charging and discharging of the battery pack such that the set limit value is not exceeded.

According to still another aspect of the disclosure, there is provided a charging and discharging control method of controlling charging and discharging of a battery pack in which a plurality of parallel battery blocks including a plurality of battery elements which is connected in parallel is connected in series. The charging and discharging control method includes: estimating a current ratio of an average value of currents flowing in the plurality of battery elements to a maximum current with a largest magnitude out of the currents flowing in the plurality of battery elements based on a temperature deviation between the plurality of battery elements which is connected in parallel and a resistance ratio between a first combined resistance value of an internal resistor of a first block out of the plurality of parallel battery blocks and a second combined resistance value of an internal resistor of a second block; setting at least one of a charging power limit value and a discharging power limit value of the battery pack using the estimated current ratio; and controlling charging and discharging of the battery pack such that the set limit value is not exceeded.

According to the present disclosure, it is possible to provide a charging and discharging control device for a battery pack and a charging and discharging control method of a battery pack that can appropriately protect a battery pack including a plurality of batteries which is connected in parallel.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of a configuration of a vehicle in which a charging and discharging control device for a battery pack according to an embodiment is mounted;

FIG. 2 is a diagram illustrating an example of a detailed configuration of the battery pack illustrated in FIG. 1;

FIG. 3 is a flowchart illustrating an example of a process routine which is performed by an ECU;

FIG. 4 is a flowchart illustrating an example of a parallel gain calculating process routine;

FIG. 5 is a diagram illustrating an example of change of a current and change of Ilimi(t) at the time of charging of the battery pack;

FIG. 6 is a diagram illustrating why a parallel gain has a value of the first power; and

FIG. 7 is a diagram illustrating an NWin/NWout calculating process routine.

### DETAILED DESCRIPTION OF EMBODIMENTS

Hereinafter, an embodiment of the present disclosure will be described in detail with reference to the accompanying drawings. The same or corresponding elements in the drawings will be referred to by the same reference signs and description thereof will not be repeated.

### Configuration of Vehicle

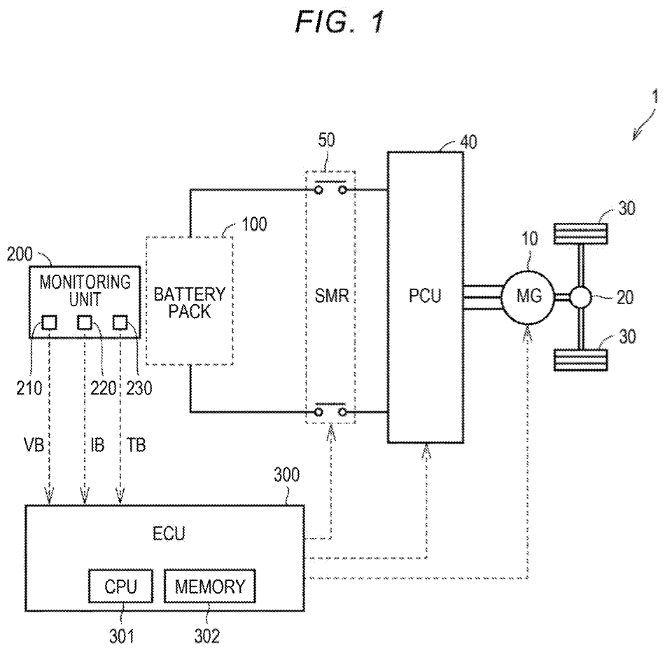

An example in which a charging and discharging control device for a battery pack according to an embodiment of the present disclosure is mounted in a vehicle will be described below. FIG. 1 is a diagram illustrating an example of a configuration of a vehicle 1 in which a charging and discharging control device for a battery pack according to the embodiment is mounted.

In this embodiment, the vehicle 1 is, for example, an electric vehicle. The vehicle 1 includes a motor generator (MG) 10, a power transmission gear 20, driving wheels 30, a power control unit (PCU) 40, a system main relay (SMR) 50, a battery pack 100, a monitoring unit 200, and an electronic control unit (ECU) 300.

The MG 10 is, for example, a three-phase alternating-current rotary electric machine and functions as an electric motor (motor) and as a power generator (generator). An output torque of the MG 10 is transmitted to the driving wheels 30 via the power transmission gear 20 including a reduction gear and a differential gear.

When the vehicle 1 is braked, the MG 10 is driven by the driving wheels 30 and the MG 10 operates as a power generator. Accordingly, the MG 10 also serves as a brake device that performs regenerative braking of converting kinetic energy of the vehicle 1 into electric power. The regenerative power which is generated by a regenerative braking force in the MG 10 is stored in the battery pack 100.

The PCU 40 is a power conversion device that bidirectionally converts electric power between the MG 10 and the battery pack 100. The PCU 40 includes an inverter and a converter that operate, for example, based on a control signal from the ECU 300.

At the time of discharging of the battery pack 100, the converter steps up a voltage which is supplied from the battery pack 100 and supplies the stepped-up voltage to the inverter. The inverter converts DC power which is supplied from the converter into AC power and drives the MG 10.

On the other hand, at the time of charging of the battery pack 100, the inverter converts AC power which is generated by the MG 10 into DC power and supplies the converted DC power to the converter. The converter steps down a voltage which is supplied from the inverter into a voltage which is suitable for charging of the battery pack 100 and supplies the stepped-down voltage to the battery pack 100.

The PCU 40 stops charging and discharging by stopping the operations of the inverter and the converter based on a control signal from the ECU 300. The ECU 40 may have a configuration in which the converter is omitted.

The SMR 50 is electrically connected to a power line that connects the battery pack 100 to the PCU 40. When the SMR 50 is closed (that is, turned on) in accordance with a control signal from the ECU 300, electric power can be transmitted between the battery pack 100 and the PCU 40. On the other hand, when the SMR 50 is open (that is, turned off) in accordance with a control signal from the ECU 300, electrical connection between the battery pack 100 and the PCU 40 is cut off

The battery pack 100 is a power storage device that stores electric power for driving the MG 10. The battery pack 100 is a DC power source which is rechargeable and has, for example, a configuration in which a plurality of parallel battery blocks in which a plurality of cells (battery elements) is connected in parallel is connected in series. Each cell includes a secondary battery such as a lithium-ion secondary battery. The detailed configuration of the battery pack 100 will be described later.

The monitoring unit 200 includes a voltage detecting unit 210, a current detecting unit 220, and a temperature detecting unit 230. The voltage detecting unit 210 detects a voltage VB between terminals of each of a plurality of parallel battery blocks. The current detecting unit 220 detects a current IB which is input to and output from the battery pack 100. The temperature detecting unit 230 detects a temperature TB of each of a plurality of cells. The detecting units output the results of this detection to the ECU 300.

The ECU 300 includes a central processing unit (CPU) 301 and a memory (for example, which includes a read only memory (ROM) and a random access memory (RAM)) 302. The ECU 300 controls devices such that a state of the vehicle 1 becomes a desired state based on a signal received from the monitoring unit 200 and information such as a map and a program which are stored in the memory 302.

An amount of electric power stored in the battery pack 100 is generally managed based on a state of charge (SOC) which represents a percent ratio of a current amount of electric power stored to a full charging capacity. The ECU 300 a function of sequentially calculating the SOC of the battery pack 100 (an SOC of each parallel battery block which will be described later or an SOC for each cell) based on detected values from the voltage detecting unit 210, the current detecting unit 220, and the temperature detecting unit 230. Various known methods such as a method using an integrated current value (a Coulomb count) and a method using estimation of an open-circuit voltage (OCV) can be employed as the method of calculating an SOC.

The ECU 300 is configured to control charging and discharging power of the battery pack 100 based on a charging power limit value Win indicating an upper limit value of charging power of the battery pack 100 and a discharging power limit value Wout indicating an upper limit value of discharging power of the battery pack 100. The ECU 300 adjusts the charging power of the battery pack 100 such that the charging power of the battery pack 100 does not exceed the charging power limit value Win. The ECU 300 adjusts the discharging power of the battery pack 100 such that the discharging power of the battery pack 100 does not exceed the discharging power limit value Wout. This adjustment is performed, for example, by controlling the PCU 40. The ECU 300 sets the charging power limit value Win and the discharging power limit value Wout based on a state of the battery pack 100. A detailed method of setting the charging power limit value Win and the discharging power limit value Wout in this embodiment will be described later.

While the vehicle 1 is operating, the battery pack 100 is charged or discharged with regenerative power or discharging power of the MG 10. The ECU 300 controls the output of the MG 10 (that is, the PCU 40) such that power for generating a driving force of the vehicle (a required driving force which is set based on an accelerator operation amount) or a braking force (a required deceleration force which is set based on a brake pedal operation amount or a vehicle speed) which is required by a driver is output from the MG 10.

### Detailed Configuration of Battery Pack 100

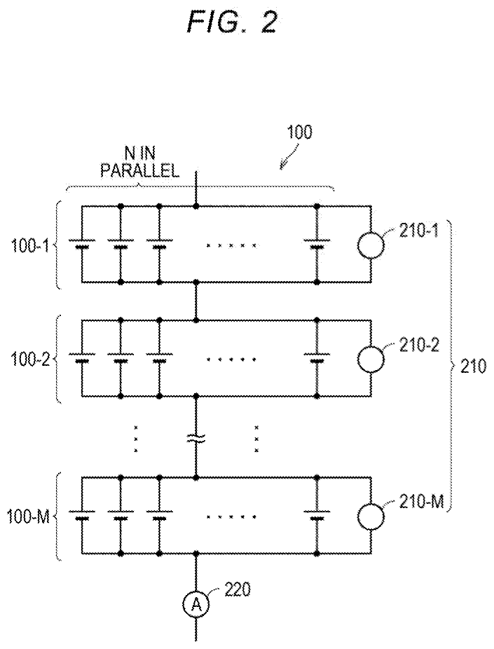

FIG. 2 is a diagram illustrating an example of a detailed configuration of the battery pack 100 illustrated in FIG. 1. Referring to FIG. 2, the battery pack 100 has a configuration in which a plurality of (for example, N) cells is connected in parallel to form a parallel battery block and a plurality of (for example, M) parallel battery blocks is connected in series.

Specifically, the battery pack 100 includes parallel battery blocks 100-1 to 100-M which are connected in series and each of the parallel battery blocks 100-1 to 100-M includes N cells which are connected in parallel.

The voltage detecting unit 210 includes voltage sensors 210-1 to 210-M. Each of the voltage sensors 210-1 to 210-M detects an inter-terminal voltage of the corresponding one of the parallel battery blocks 100-1 to 100-M. That is, the voltage sensor 210-1 detects an inter-terminal voltage VB1 of the parallel battery block 100-1. Similarly, the parallel battery blocks 100-2 to 100-M detect inter-terminal voltages VB2 to VBM of the voltage sensors 210-2 to 210-M, respectively. The voltage detecting unit 210 transmits the detected inter-terminal voltages VB1 to VBM as the voltage VB to the ECU 300. The current detecting unit 220 detects a current IB which flows in the parallel battery blocks 100-1 to 100-M. That is, the current detecting unit 220 detects a total current (which may be referred to as Iₜₒₜₐₗ in the following description) which flows in the N cells of each parallel battery block.

### Setting of Charging Power Limit Value Win and Discharging Power Limit Value Wout

Protection of the battery pack 100 which is mounted in the vehicle 1 having the above-mentioned configuration is achieved by performing charging and discharging control within a range in which a burden on the battery pack 100 does not become excessively great. However, particularly, in the battery pack 100 in which a plurality of cells is connected in parallel, a deviation of currents flowing in the cells may increase in comparison with a battery pack in which a plurality of cells is connected in series. Accordingly, even when charging and discharging are controlled in the same way as in the battery pack including only series connection, a larger current than expected may flow in any cell out of the plurality of cells and thus the battery pack 100 may not be appropriately protected.

Therefore, in this embodiment, the ECU 300 estimates a current ratio of an average value of currents flowing in the plurality of cells to a maximum current with a largest magnitude out of the currents flowing in the plurality of cells based on a temperature deviation between the plurality of cells which is connected in parallel, sets at least one of a charging power limit value and a discharging power limit value of the battery pack 100 using the estimated current ratio, and controls charging and discharging of the battery pack 100 such that the set limit value is not exceeded.

According to this configuration, the charging power limit value and the discharging power limit value can be set in consideration of the maximum current out of currents flowing in the plurality of cells which is connected in parallel. Accordingly, by controlling charging and discharging of the battery pack 100 such that the set limit value is not exceeded, it is possible to curb occurrence of abnormalities in the battery pack 100 and to appropriately protect the battery pack 100.

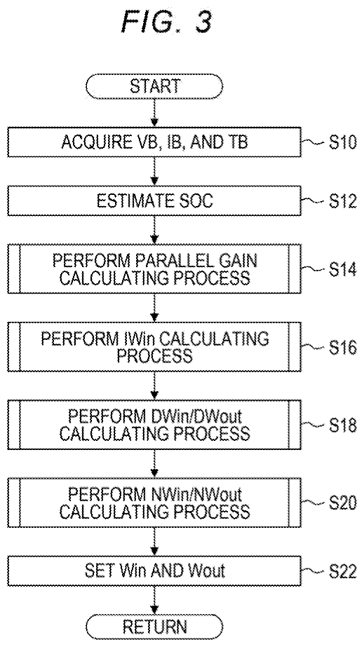

Hereinafter, a process of setting the charging power limit value Win and the discharging power limit value Wout, which is performed by the ECU 300, will be described with reference to FIG. 3. FIG. 3 is a flowchart illustrating an example of a process which is performed by the ECU 300. The control process illustrated in this flowchart is performed by the ECU 300 illustrated in FIG. 1 at intervals of a predetermined period (for example, at a time point at which a predetermined period elapses from a time point at which a previous process has ended).

In Step (hereinafter referred to as “S”) 10, the ECU 300 acquires the S voltage VB of each parallel battery block, the current IB flowing in the battery pack 100, and the temperature TB of each cell. The ECU 300 acquires the voltage VB, the current IB, and the temperature TB from the monitoring unit 200.

In S12, the ECU 300 estimates the SOC of each cell. The method of estimating the SOC is the same as described above and thus detailed description thereof will not be repeated.

In S14, the ECU 300 performs a parallel gain calculating process. A parallel gain represents a deviation of currents and is used to calculate, for example, a current with a maximum deviation (hereinafter also referred to as a maximum current) from an average value of the detected currents. That is, the parallel gain represents a current ratio of the average value of the currents detected by the current detecting unit 220 to the maximum current. Details of the parallel gain calculating process will be described later.

In S16, the ECU 300 performs a calculation process of calculating IWin (hereinafter referred to as an IWin calculating process) using the parallel gain. IWin represents a charging power limit value which is set such that metallic lithium is not extracted on the surface of a negative electrode of a cell which is included in the battery pack 100 at the time of charging of the battery pack 100. Details of the IWin calculating process will be described later.

In S18, the ECU 300 performs a calculation process of calculating DWin and DWout (hereinafter referred to as a DWin/DWout calculating process) using the parallel gain. DWin represents a charging power limit value which is set to curb high-rate deterioration of each cell at the time of charging of the battery pack 100. DWout represents a discharging power limit value which is set to curb high-rate deterioration of each cell at the time of discharging of the battery pack 100. Details of the DWin/DWout calculating process will be described later.

In S20, the ECU 300 performs a calculation process of calculating NWin and NWout (hereinafter referred to as an NWin/NWout calculating process). NWin represents a charging power limit value which is set such that the temperature of each cell does not exceed an upper-limit temperature at the time of charging of the battery pack 100. NWout represents a discharging power limit value which is set such that the temperature of each cell does not exceed the upper-limit temperature at the time of discharging of the battery pack 100. Details of the NWin/NWout calculating process will be described later.

In S22, the ECU 300 sets the charging power limit value Win and the discharging power limit value Wout. Specifically, for example, the ECU 300 sets the smallest value of IWin, DWin, and NWin as the charging power limit value Win. In addition, the ECU 300 sets the smallest one of DWout and NWout as the discharging power limit value Wout.

When the charging power limit value Win and the discharging power limit value Wout are set through the process illustrated in FIG. 3, the ECU 300 controls the current or the voltage of the battery pack 100 using the PCU 40 such that the charging power does not exceed the charging power limit value Win at the time of charging of the battery pack 100. On the other hand, the ECU 300 controls the current or the voltage of the battery pack 100 using the PCU 40 such that the discharging power does not exceed the discharging power limit value Wout at the time of discharging of the battery pack 100. Any known technique can be used for control of the current and the voltage and detailed description thereof will not be given.

### Parallel Gain Calculating Process

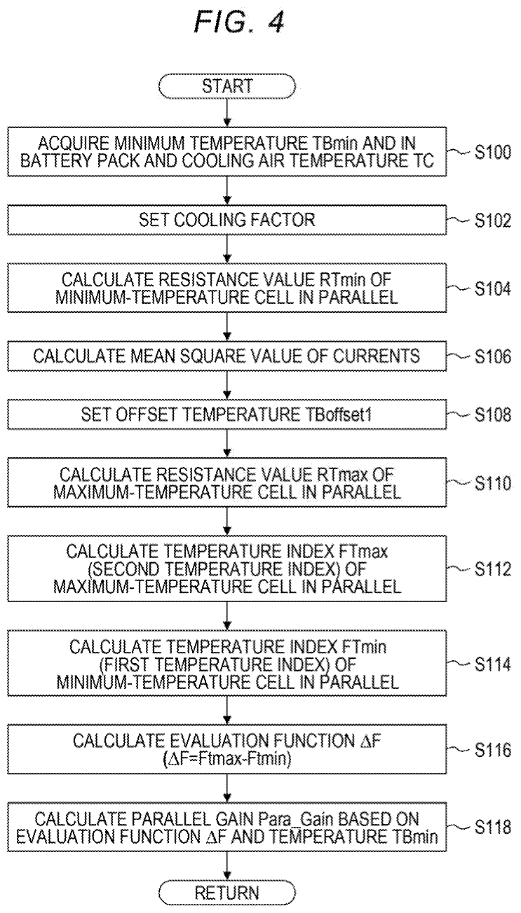

Hereinafter, the parallel gain calculating process will be described with reference to FIG. 4. FIG. 4 is a flowchart illustrating an example of a parallel gain calculating process. The process illustrated in the flowchart is performed for each parallel battery block in the battery pack 100 by the ECU 300 illustrated in FIG. 1.

In S100, the ECU 300 acquires a minimum temperature TBmin and a temperature TC of cooling air in the battery pack 100. The ECU 300 acquires a minimum temperature out of the temperatures of the cells which are detected by the temperature detecting unit 230 as the minimum temperature TBmin. The ECU 300 acquires the cooling air temperature TC from the temperature of air (intake air temperature) which is sucked into the battery pack 100. The intake air temperature is detected, for example, using a temperature sensor (not illustrated) which is provided at an inlet through which cooling air for the frame of the battery pack 100 is introduced.

In S102, the ECU 300 calculates a cooling factor h. The ECU 300 sets the cooling factor h using an amount of operation of a cooling device (for example, a fan) for the battery pack 100 and a map (or a numerical expression) indicating a relationship between the amount of operation and the cooling factor h. The map indicating the amount of operation and the cooling factor h is prepared by experiment or the like. The relationship between the amount of operation and the cooling factor h represents, for example, that the value of the cooling factor h increases as an air volume increases.

In S104, the ECU 300 calculates a resistance value Ftmin of a minimum-temperature cell out of a plurality of cells which is connected in parallel. The ECU 300 calculates Rtmin, for example, using Equation (1).

Rtmin(t)=Rivmax×f(TBmin(t), RAHRmin(t)) (1)

Rivmax in Equation (1) represents a minimum value of unevenness in initial resistance (product unevenness) which exists between the cells. Rivmax is acquired in advance by experiment or the like. In addition, f is a coefficient indicating a decrease in resistance from an initial resistance value (Rivmax or Rivmin which will be described later) and is a function (a map) having the temperature of a cell and a residual capacity (RAHR) as arguments.

In Equation (1), “t” represents a calculated value in the current operation cycle. RAHRmin represents the lowest RAHR out of the RAHRs of the blocks.

In S106, the ECU 300 calculates a mean square value IBa of the current IB. The ECU 100 calculates the mean square value IBa of the currents, for example, using a current value of the current detected by the current detecting unit 220 and a predetermined number of detection results which were detected in a predetermined previous period as represented by Equation (2). The ECU 100 may calculate a current value, for example, by adding a value, which is obtained by multiplying a difference between a previous value and a current mean square value by a predetermined constant (a smoothing constant) k, to the previous value as represented by Equation (3) instead of using Equation (2).

IBa(t)=√{IB(t)²+IB(t−1)²+ . . . +IB(t−n)²} (2)

IBa(t)=IBa(t−1)+k×(√{IB(t)²+IB(t−1)²+ . . . +IB(t−n)²}−IBa(t−1)) (³⁾

In S108, the ECU 300 sets an offset temperature TBoffset1. The offset temperature TBoffset1 represents an offset temperature for calculating the temperature of a maximum-temperature cell using the temperature of a minimum-temperature cell and also represents a temperature deviation between a plurality of cells which is connected in parallel. The ECU 300 sets the offset temperature TBoffset1, for example, using a current value IBa(t) of the mean square value and a map (or a numerical expression or the like) indicating a relationship between the mean square value and the offset temperature TBoffset1. The map indicating the relationship between the mean square value and the offset temperature TBoffset1 is prepared by experiment or the like. The relationship between the mean square value and the offset temperature TBoffset1 represents, for example, that the amount of heat emitted in the battery pack 100 increases and the temperature deviation increases as the mean square value increases, thereby increasing the value of the offset temperature TBoffset1.

In S110, the ECU 300 calculates a resistance value Rtmax of a maximum-temperature cell out of a plurality of cells which is connected in parallel. The ECU 300 calculates Rtmax, for example, using Equation (4).

Rtmax(t)=Rivmin×f(TBmin(t)+TBoffset1, RAHRmin(t)+RAHRoffset) . . . (4)

Rivmin in Equation (4) represents a minimum value of unevenness in initial resistance (product unevenness) which exists between the cells. Since the maximum-temperature cell has a higher cell temperature and a lower resistance value than that of the minimum-temperature cell, Rivmin is used to calculate resistance Rtmax of the maximum-temperature cell and Rivmax is used to calculate resistance Rtmin of the minimum-temperature cell. Rivmin is acquired in advance by experiment or the like.

As described above, f is a coefficient indicating a decrease in resistance from an initial resistance value (Rivmin or Rivmax) and is a function (a map) having the temperature of a cell and a residual capacity (RAHR) as arguments. In Equation (4), the temperature of the maximum-temperature cell, that is, a value obtained by adding the offset temperature TBoffset1 to the temperature TBmin of the minimum-temperature cell, is used as an argument. An offset value RAHRoffset is a predetermined value which is used to calculate RAHRmax indicating the highest RAHR out of RAHRs of the blocks using RAHRmin.

The coefficient f which is used for Equations (1) and (4) is determined based on a cell temperature and a residual capacity RAHR. Basically, the coefficient f has a greater value as the temperature decreases and RAHR decreases, and the coefficient f has a smaller value as the temperature increases and RAHR increases. The specific values of the map are determined in advance by experiment or the like.

In S112, the ECU 300 calculates a temperature index Ftmax of the maximum-temperature cell (a second temperature index) out of a plurality of cells which is connected in parallel using the following equations.

Ftmax(t)=Ftmax(t−1)+Fk×(Qtmax(t)−Ctmax(t)) (5)

Qtmax(t)=Qtmax(t−1)+Qktmax×(Rtmax(t)×Itmax(t)²×dt−Qtmax(t−1)) (6)

Ctmax(t)=Ctmax(t−1)+Cktmax×(h(t)×(TBmin(t)+TBoffset2−TC(t))×dt−Ctmax (t−1)) (7)

In the equations, Qtmax represents an amount of heat emitted in the maximum-temperature cell (a heat emission term due to supply of power), and Ctmax represents an amount of cooling of the maximum-temperature cell (a cooling term due to a cooling device). Fk is a predetermined correction coefficient. In Equation (6), Itmax represents the current of the maximum-temperature cell and Qktmax is a predetermined constant (a smoothing constant). Itmax is calculated by Equation (11).

In Equation (7), TBoffset2 represents an offset value which is used to calculate the cooling term of the maximum-temperature cell such that it is greater than the cooling term of the minimum-temperature cell.

The ECU 300 calculates Rtmax and Itmax and calculates the amount of heat emitted Qtmax of the maximum-temperature cell by Equation (6) using the calculated Rtmax and Itmax. Then, the ECU 300 calculates the temperature index Ftmax of the maximum-temperature cell (the second temperature index) by Equation (5) using the calculated amount of heat emitted Qtmax and the amount of cooling Ctmax which is calculated by Equation (7).

In S114, the ECU 300 calculates a temperature index Ftmin of the minimum-temperature cell (a first temperature index) out of a plurality of cells which is connected in parallel using the following equations.

Ftmin(t)=Ftmin(t−1)+Fk×(Qtmin(t)−Ctmin(t)) (8)

Qtmin(t)=Qtmin(t−1)+Qktmin×(Rtmin(t)×Itmin(t)²×dt−Qmin(t−1)) (9)

Ctmin(t)=Ctmin(t−1)+Cktmin×(h(t)×(TBmin(t)−TC(t))×dt−CTmin(t−1)) (10)

Qtmin represents an amount of heat emitted in the minimum-temperature cell (a heat emission term due to supply of power), and Ctmin represents an amount of cooling of the minimum-temperature cell (a cooling term due to the cooling device). In Equation (9), Itmin represents the current of the minimum-temperature cell and Qktmin is a predetermined constant (a smoothing constant). Itmin is calculated by Equation (12).

The ECU 300 calculates Rtmin and Itmin and calculates the amount of heat emitted Qtmin of the minimum-temperature cell by Equation (9) using the calculated Rtmin and Itmin. Then, the ECU 300 calculates the temperature index Ftmin of the minimum-temperature cell (the first temperature index) by Equation (8) using the calculated amount of heat emitted Qtmin and the amount of cooling Ctmin which is calculated by Equation (10).

Itmax (the current of the maximum-temperature cell) in Equation (6) and Itmin (the current of the minimum-temperature cell) in Equation (9) are estimated based on the assumption that one of the maximum-temperature cell and the minimum-temperature cell out of a plurality of cells which is connected in parallel is used as a target cell and in consideration of disconnection in any cell (when disconnection occurs, a current in another cell may increase and a current deviation may increase) using the following equations.

$$\begin{matrix}It max ( t ) = \frac{\begin{matrix}Rt min \\ N - N 1 - N 2\end{matrix}}{\frac{Rt max}{N 1} + \frac{Rt min}{N - N 1 - N 2}} \times \frac{I ( t )}{N 1} & ( 11 ) \\ It min ( t ) = \frac{\frac{Rt max}{N 1}}{\frac{Rt max}{N 1} + \frac{Rt min}{N - N 1 - N 2}} \times \frac{I ( t )}{N - N 1 - N 2} & ( 12 )\end{matrix}$$

N represents the number of cells in parallel in each block (FIG. 2). N1 represents the number of maximum-temperature cells out of N cells which are connected in parallel and N2 represents the number of cells disconnected. Equations (11) and (12) can be easily derived using Rtmax (resistance of the maximum-temperature cell) and Rtmin (resistance of the minimum-temperature cell) which are calculated by Equations (4) and (1) and the like.

In this embodiment, it is assumed that unevenness in current is the greatest in a state in which the battery pack 100 is available, N1=1 is set (a degree of concentration of a current in the maximum-temperature cell is the largest), and a worst value (for example, N2=2 with respect to N=15) in the state in which the battery pack 100 is available is set as N2.

Referring back to FIG. 4, in S116, the ECU 300 calculates an evaluation function ΔF indicating a degree of temperature deviation between cells by subtracting the temperature index Ftmin of the minimum-temperature cell from the temperature index Ftmax of the maximum-temperature cell as represented by Equation (13).

ΔF(t)=Ftmax(t)−Ftmin(t) (13)

In S118, the ECU 100 calculates a parallel gain Para_Gain indicating a degree of current deviation between cells using the calculated evaluation function ΔF and the temperature TBmin indicating the minimum temperature in the battery pack 100.

The parallel gain Para_Gain is determined by the evaluation function ΔF and the temperature TBmin. The parallel gain Para_Gain has a larger value as the unevenness in current becomes greater and, substantially, the parallel gain Para_Gain has a larger value as the evaluation function ΔF has a larger value (the unevenness in temperature becomes greater) and as the temperature TBmin decreases. For example, the parallel gain Para_Gain represents a current ratio of a value (an average current), which is obtained by dividing the current detected by the current detecting unit 220 by the number of cells, to the maximum current out of the currents flowing in the cells in parallel. In this embodiment, the parallel gain Para_Gain represents a ratio of the maximum current to the average current.

### IWin Calculating Process

The IWin calculating process will be described below. The ECU 300 sets IWin such that the current IB becomes greater than an allowable charging current value (hereinafter also referred to as Ilim) with change in the current IB (that is, such that the magnitude of the current IB becomes less than the magnitude of the allowable charging current value) at the time of charging of the battery pack 100 (that is, when the current IB has a negative value). Specifically, the ECU 300 calculates IWin using Equation (14).

IWin(t)=Win_nb(t)−Kp×(Itag(t)−IB(t)) (14)

Here, IWin(t) represents IWin at time t, and Win_nb(t) represents base power and is a feed-forward term which is calculated using Itag(t) and Vtag(t). Kp represents a feedback coefficient. Itag(t) represents a threshold value (an allowable charging current target value) at which feedback control of the charging power limit value is started such that the current IB is not less than an allowable input current value. The ECU 300 calculates Win nb(t) using Equation (15).

Win _nb(t)=Vtag(t)×Itag(t)/Para_Gain(t) (15)

Here, Vtag(t) represents a voltage when the battery pack is charged with the current Itag(t). The ECU 300 calculates Vtag(t) using Equation (16).

Vtag(t)=VAocv(t)−R(TB(t), SOC(t))×Itag(t)/Para_Gain(t) (16)

Here, VAocv(t) represents an estimated electromotive voltage for each parallel battery block and is calculated using the voltage VB which is detected by the voltage detecting unit 210. R(TB(t), SOC(t)) represents internal resistance of the parallel battery block at the temperature TB(t) and the SOC(t) at time t. The ECU 300 calculates Itag(t) using Equation (17).

Itag(t)=Ilim(t)+Itag_offset(t) (17)

Here, Itag_offset may be a predetermined value or may be set using at least one of the TB(t) and the SOC(t). Ilim(t) represents an allowable charging current value. The ECU 300 calculates Ilim(t) using Equation (18).

Ilim(t)=Ilim(0)+∫₀^{T}F(IB(t), TB(t), SOC(t))dt−∫₀^{T}G(t,TB(t), SOC(t))dt (18)

Here, the first term (that is, Ilim(0)) on the right side of the equality sign in Equation (18) represents a maximum current value at which metallic lithium is not extracted within a unit time when the battery pack is charged in a state in which there is no charging/discharging history. The second term on the right side of the equality sign in Equation (18) represents a decrease term of the allowable current value due to charging which is continuously performed from the state in which there is no charging/discharging history to time T, and the third term represents a recovery term due to the elapse of time. The ECU 300 calculates Ilim(t) using Equation (19) during charging (that is, when there is a charging/discharging history).

$$I lim ( t ) = I lim ( t - 1 ) - f ( IB ( t ) , TB ( t ) , SOC ( t ) ) \times dt - g ( TB ( t ) , SOC ( t ) ) \times \frac{I lim ( 0 ) - I lim ( t - 1 )}{I lim ( 0 )} \times dt \qquad ( 19 )$$

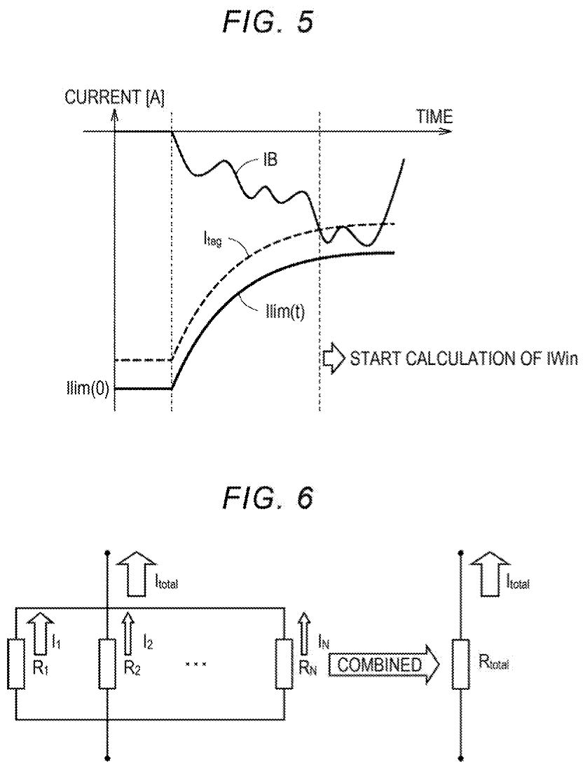

FIG. 5 is a diagram illustrating an example of change of the current IB and change of the current limit(t) at the time of charging of the battery pack 100. The vertical axis of FIG. 5 represents a current. The horizontal axis of FIG. 5 represents a time. As illustrated in FIG. 5, at time t1, limitation based on IWin is not performed until the current IB reaches Itag. At time t1, when the current IB reaches Itag, limitation based on IWin is started.

That is, the ECU 300 calculates IWin(t) using Equation (14), for example, when the current IB is less than Itag. Then, when a difference between the current IB and Itag increases, the change in IWin also increases. Accordingly, approach of the current IB to Ilim(t) is curbed. Then, the ECU 300 sets IWin=0 when the current IB reaches (decreases to) Ilim(t). The ECU 300 may calculate IWin in consideration of a detection error of the current detecting unit 220, deterioration of a cell, or the like. The ECU 300 may set an upper limit value for the magnitude of change of IWin per unit time. The ECU 300 calculates IWin for each parallel battery block and sets the smallest value of the absolute values of the calculated values of IWin as a final value of IWin.

### DWin/DWout Calculating Process

The DWin/DWout calculating process will be described below. The ECU 300 sets DWin and DWout such that a plurality of cells of the battery pack 100 does not deteriorate at a high rate at the time of charging or discharging of the battery pack 100.

The ECU 300 determines whether high-rate charging is performed, for example, based on a charging/discharging intensity of each cell, and performs power limitation when it is determined that high-rate charging is performed. Similarly, the ECU 300 determines whether there is a sign of high-rate deterioration, for example, based on a degree of deterioration, and performs power limitation when it is determined that there is a sign of high-rate deterioration.

More specifically, the ECU 300 sets DWin/DWout based on a result of comparison between a power limit value DWin_pow/DWout_pow which is set based on a charging/discharging intensity index D_pow and a power limit value DWin_dam/DWout_dam which is set based on a positive-negative-electrode salt concentration unevenness index D_dam. For example, the ECU 300 sets the larger value (the smaller absolute value) of DWin_pow and DWin_dam as DWin. Similarly, for example, the ECU 300 sets the smaller value (the smaller absolute value) of DWout_pow and DWout_dam as DWout.

The method of calculating DWin_pow/DWoutP_pow and DWin_dam/DWout_dam will be described below.

The ECU 300 calculates DWin_pow and DWout_pow using Equations (20) and (21).

DWin_pow=SWin+DWin_pow Correction Value (20)

DWout_pow=SWin+DWout_pow Correction Value (21)

Herein, SWin is a preset reference value of a charging power limit value and is set, for example, based on the temperature of the battery pack 100 or the like. SWout is a preset reference value of a discharging power limit value and is set, for example, based on the temperature of the battery pack 100 or the like. Both of the DWin_pow correction value and the DWout_pow correction value are set such that the charging/discharging intensity index D_pow does not exceed a predetermined threshold value indicating a battery usage limit.

The charging/discharging intensity index D_pow when calculating DWin is divided into charging and discharging, which are calculated using Equations (22) and (23).

$$\begin{matrix} ( Charging ) & \\ D\_pow \_ch ( t + Δ t ) = ( 1 - α \times Δ t ) \times D\_pow \_ch ( t ) + \frac{β}{c 0 \_pow \_ch 1} \times IB \times Para\_Gain \times Δ t & ( 22 ) \\ ( Discharging ) & \\ D\_pow \_ch ( t + Δ t ) = ( 1 - α \times Δ t ) \times D\_pow \_ch ( t ) + \frac{β}{c 0 \_pow \_ch 2} \times IB \times Para\_Gain \times Δ t & ( 23 )\end{matrix}$$

The charging/discharging intensity index D_pow when DWout is calculated is divided into charging and discharging, which are calculated using Equations (24) and (25).

$$\begin{matrix} ( Charging ) & \\ D\_pow \_dc ( t + Δ t ) = ( 1 - α \times Δ t ) \times D\_pow \_dc ( t ) + \frac{β}{c 0 \_pow \_dc 1} \times IB \times Para\_Gain \times Δ t & ( 24 ) \\ ( Discharging ) & \\ D\_pow \_dc ( t + Δ t ) = ( 1 - α \times Δ t ) \times D\_pow \_dc ( t ) + \frac{β}{c 0 \_pow \_dc 2} \times IB \times Para\_Gain \times Δ t & ( 25 )\end{matrix}$$

In Equations (22) to (25), At represents an operation cycle (for example, 0.1 second). α represents a forgetting coefficient and is set, for example, by the cell SOC and the battery temperature. 62 represents a current coefficient and is set, for example, by the cell SOC and the battery temperature. c0_pow_ch1, c0_pow ch2, c0_pow dc1, and c0_pow_dc2 represent marginal threshold values which are set depending on which of DWin and DWout is to be calculated and which of charging and discharging is to be performed. These values are set by the cell SOC and the battery temperature. c0_pow ch1, c0_pow ch2, c0_pow dc1, and c0_pow dc2 are set, for example, such that D_pow_ch is −1 and D_pow_dc is 1 in a battery use-limited state. By controlling charging and discharging such that D_pow_ch does not exceed -1 and D_pow_dc does not exceed 1, it is possible to prevent a parallel battery block from reaching the battery use-limited state.

The DWin_pow correction value and the DWout_pow correction value are calculated by Equations (26) and (27) using the calculated charging/discharging intensity index D_pow.

DWin_pow Correction Value=Kp_in×(Dtag_in−D_pow_ch)+Ki_in×∫(Dtag_in−D_pow_ch)dt (26)

DWout_pow Correction Value=Kp_out×(Dtag_out−D_pow_ch)+Ki_out×∫(Dtag_out−D_pow_ch)dt (27)

Here, Kp_in and Kp_out in Equations (26) and (27) represent P control gains in feedback control for changing D_pow_ch and D_pow_dc to follow Dtag_in and DtagP_out. Ki_in and Ki_out in Equations (26) and (27) represent I control gains in the feedback control. Dtag_in and Dtag_out represent target values for preventing D_pow_ch and D_pow_dc from exceeding allowable values (−1, 1) and are set, for example, using the cell SOC or the battery temperature TB. A predetermined upper-limit guard or a lower-limit guard may be set in the DWinP_pow correction value and the DWout_pow correction value.

The ECU 300 calculates DWin_dam and DWout_dam using Equations (28) and (29).

DWin_dam=SWin+DWin_dam Correction Value (28)

DWout_dam=SWout+DWout_dam Correction Value (29)

Here, the DWin_dam correction value and the DWout_dam correction value are set such that cumulative damage of the cells does not exceed an allowable value.

The positive-negative-electrode salt concentration unevenness index D_dam when DWin is calculated is divided into charging and discharging and is calculated using Equations (30) and (31).

$$\begin{matrix} ( Charging ) & \\ D\_dam \_ch ( t + Δ t ) = ( 1 - α\_ch 1 \times Δ t ) \times D\_dam \_ch ( t ) + \frac{β}{c 0 \_dam \_ch 1} \times IB \times Para\_Gain \times Δ t & ( 30 ) \\ ( Discharging ) & \\ D\_dam \_ch ( t + Δ t ) = ( 1 - α\_ch 2 \times Δ t ) \times D\_dam \_ch ( t ) + \frac{β}{c 0 \_dam \_ch 2} \times IB \times Para\_Gain \times Δ t & ( 31 )\end{matrix}$$

The positive-negative-electrode salt concentration unevenness index D_dam when DWout is calculated is divided into charging and discharging as described above and is calculated using Equations (32) and (33).

$$\begin{matrix} ( Charging ) & \\ D\_dam \_dc ( t + Δ t ) = ( 1 - α\_dc 1 \times Δ t ) \times D\_dam \_dc ( t ) + \frac{β}{c 0 \_dam \_dc 1} \times IB \times Para\_Gain \times Δ t & ( 32 ) \\ ( Discharging ) & \\ D\_dam \_dc ( t + Δ t ) = ( 1 - α\_dc 2 \times Δ t ) \times D\_dam \_dc ( t ) + \frac{β}{c 0 \_dam \_dc 2} \times IB \times Para\_Gain \times Δ t & ( 33 )\end{matrix}$$

In Equations (28) to (33), At represents an operation cycle (for example, 0.1 second). Both of α_ch1 and α_ch2 represent forgetting coefficients and are set, for example, by the cell SOC and the battery temperature. β represents a current coefficient and is set, for example, by the cell SOC and the battery temperature. c0_dam_ch1, c0_dam_ch2, c0_am dc1, and c0_dam_dc2 represent marginal threshold values which are set depending on which of DWin and DWout is to be calculated and which of charging and discharging is to be performed. These values are set by the cell SOC and the battery temperature. For example, c0_dam_ch1, c0_dam_ch2, c0_dam_dc1, and c0_dam_dc2 are set such that an appropriate correlation between the cumulative damage and the salt concentration unevenness in an in-plane direction (for example, a direction parallel to one of two planes having the large area out of the planes forming a cell of a rectangular parallelepiped shape) is formed.

The cumulative damage is calculated using the calculated positive-negative-electrode salt concentration unevenness index D_dam. As the cumulative damage, charging-side cumulative damage and discharging-side cumulative damage are separately calculated and the cumulative damage is separately calculated when D_dam is equal to or greater than 0 and when D_dam is less than 0. The ECU 300 calculates a charging-side cumulative damage Dam_ch using Equations (34) and (35).

(Charging)

Dam_ch(t +Δt)=γ₁_ch×Dam_ch(t)+ηch2)×(D_dam_ch(t)−border (+side)) (D≥0) (34)

(Discharging)

Dam_ch(t+Δt)=γ₁_ch×Dam_ch(t)+(η_ch1+ηch2)×(D_dam_ch(t)−border (−side)) (D<0) (35)

The ECU 300 calculates a discharging-side cumulative damage Dam_dc using Equations (36) and (37).

(Charging)

Dam_ch(t+Δt)=γ₁_dc×Dam_dc(t)+ηdc1×ηdc2)×(D_dam_dc(t)−border (+side)) (D≥0) (36)

(Discharging)

Dam_dc(t+Δt)=γ₁_dc×Dam_dc(t)+(η_dc1+ηdc2)×(D_dam-dc(t−border (−side)) (D<0) (37)

In Equations (34) to (37), At represents an operation cycle (for example, 0.1 second). γ₁_ch and γ₁_dc represent attenuation coefficients and are set using a map having the cumulative damage and the battery temperature for each cell as arguments, or the like. η_ch1 represents a first proportional coefficient at the time of calculating the charging-side cumulative damage and η_dc1 represents a first proportional coefficient at the time of calculating the discharging-side cumulative damage, both of which are set using the current IB×Para_Gain and the temperature TB as arguments, or the like. η_ch2 represents a second proportional coefficient at the time of calculating the charging-side cumulative damage and η_dc2 represents a second proportional coefficient at the time of calculating the discharging-side cumulative damage, both of which are set using the current IB×Para_Gain and the SOC as arguments, or the like. Only a magnitude exceeding a dead zone between the +border and the −border is added as cumulative damage in Equations (34) to (37).

The ECU 300 calculates the DWin_dam correction value in Equation (28) and the DWout_dam correction value in Equation (29) using Equations (38) and (39).

DWin_dam Correction Value=DWin_dam Correction Value 1+DWin_dam Correction Value 2 (38)

DWout_dam Correction Value=DWout_dam Correction Value 1+DWout_dam Correction Value 2 (39)

Then, the ECU 300 calculates DWin_dam correction value 1, DWin_dam correction value 2, DWout_dam correction value 1, and DWout_dam correction value 2 using Equations (40) to (43).

DWin_dam Correction Value 1=−kp_dam_in_1×(Dam(t)−Dam-tag) (40)

DWout_dam Correction Value 1=−kp_dam_out_1×(Dam(t)−Damtag) (41)

DWin_dam Correction Value 2(t+Δt)=DWin_dam Correction Value 2(2)−kp_dam_in_2×(Dam(t)−Dam_tag) (42)

DWout_dam Correction Value 2(t+Δt)=DWout_dam Correction Value 2(2)−kp_dam_out_2×(Dam(t)−Dam_tag) (43)

Here, kp_dam_in 1, kp_dam_out 1, kp_dam_in 2, and kp_dam_out 2 are coefficients and are set using a map having the SOC and the battery temperature as arguments. Dam(t) represents one of Dam_ch(t) and Dam_dc(t). Dam tag represents a threshold value which is a value less than an allowable value of the cumulative damage and at which limitation is started using DWin or DWout. The ECU 300 calculates a correction value corresponding to a magnitude by which the cumulative damage Dam(t) is greater than Dam tag and sets DWin/DWout, whereby the cumulative damage is prevented from reaching the allowable value. For example, in consideration of further prevention of change in the battery temperature during being left alone or deterioration in drivability, the ECU 300 may set DWin_dam correction value 1, DWin_dam correction value 2, DWout_dam correction value 1, and DWout_dam correction value 2. The ECU 300 may set an upper limit value in the magnitude of change in DWin or the magnitude of change in DWout. The ECU 300 calculates DWin and DWout for each parallel battery block. The ECU 300 sets a value having the smallest absolute value out of the calculated plurality of values of DWin as a final value of DWin and sets a value having the smallest absolute value out of the calculated plurality of values of DWout as a final value of DWout.

### NWin/NWout Calculating Process

The NWin/NWout calculating process will be described below. The ECU 300 sets NWin and NWout such that the temperature in the battery pack 100 does not reach the upper limit value at the time of charging or discharging of the battery pack 100.

Specifically, the ECU 300 sets an upper-limit temperature based on the intake air temperature, the mean square value of the currents IB, and the cooling air volume and sets NWin/NWout such that the set upper-limit temperature is not exceeded.

The ECU 300 acquires, for example, a cooling air temperature TC as the intake air temperature. The ECU 300 calculates the mean square value Fbat of the currents using Equation (44).

$$Fbat ( t + 1 ) = \frac{\begin{matrix}( Kbat - 1 ) \times Fbat ( t ) + {IB ( t )}^{2} \times \\ {Para\_Gain}^{′} ( = Para\_Gain \times Rr )\end{matrix}}{Kbat} \qquad ( 44 )$$

Here, Kbat represents a constant which is used to perform a smoothing process (a gradual change process) on Fbat and is a predetermined value. A parallel gain Para_Gain′ which is used to calculate the mean square value of the currents does not have a value of the second power but has a value of the first power for the following reasons.

FIG. 6 is a diagram illustrating why a parallel gain has a value of the first power. As illustrated in FIG. 6, for example, it is assumed that there is one parallel battery block for the purpose of convenience of explanation. In this case, the parallel gain can be represented by (Rₜₒₜₐₗ/Rₘᵢₙ)×N. Here, Rₜₒₜₐₗ represents a combined value of internal resistance of the battery pack 100, Rₘᵢₙ represents a minimum value of internal resistance of N cells, and Rₜₒₜₐₗ/Rₘᵢₙ represents a ratio of the combined value of internal resistance of the battery pack 100 to the minimum value of internal resistance. At this time, a maximum current of parallel currents can be represented by Iₜₒₜₐₗ×parallel gain and corresponds to a value obtained by multiplying the maximum current Iₘₐₓ in N cells by N. Iₜₒₜₐₗ represents a sum value of I₁ to I_{N}. Accordingly, an amount of heat emitted in the battery pack 100 can be generally expressed by R₁I₁²+R₂I₂²+ . . . +R_{N}_{N}². R₁ to R_{N} represent internal resistance of the cells of the parallel battery block, respectively. I₁ to IN represent currents flowing in the cells of the parallel battery block, respectively. Here, when it is assumed that R₁ is a minimum resistance value in the parallel battery block including N cells, R₁=Rₘᵢₙ can be set and I₁=Iₘₐₓ can be set. When it is assumed that the internal resistance values in all of the N cells are Rₘᵢₙ and the currents are Iₘₐₓ, N×RₘᵢₙIₘₐₓ² can be estimated as a maximum value of the amount of heat emitted. The maximum value of the amount of heat emitted can be represented by Equation (45) by expressing the maximum value using the maximum current of the parallel currents and the parallel gain (that is, substituting the maximum current and the parallel gain thereto). Accordingly, the parallel gain Para_Gain′ has a value of the first power.

$$N \times {R}_{min} {I}_{max}^{2} = N \times \frac{{R}_{total} \times N}{{Para\_Gain}^{′}} \times {( \frac{{I}_{total} \times {Para\_Gain}^{′}}{N} )}^{2} = {Para\_Gain}^{′} \times {R}_{total} {I}_{total}^{2} \qquad ( 45 )$$

Since a plurality of parallel battery blocks is connected in series, the parallel gain Para_Gain′ which is used to calculate NWin/NWout has a value obtained by multiplying the parallel gain Para_Gain by an inter-cell resistance ratio Rr as expressed by

Equation (44). Here, the inter-cell resistance ratio Rr represents a ratio of two combined resistance values of two parallel battery blocks in which the battery temperatures are close to each other when a plurality of parallel battery blocks is connected in series. For example, the ECU 300 specifies a first combined resistance value of a first parallel battery block having a smallest temperature difference between the battery temperatures out of the plurality of parallel battery blocks and a second combined resistance value (<the first combined resistance value) of a second parallel battery block, and calculates a resistance ratio of the first combined resistance value to the second combined resistance value as the inter-cell resistance ratio.

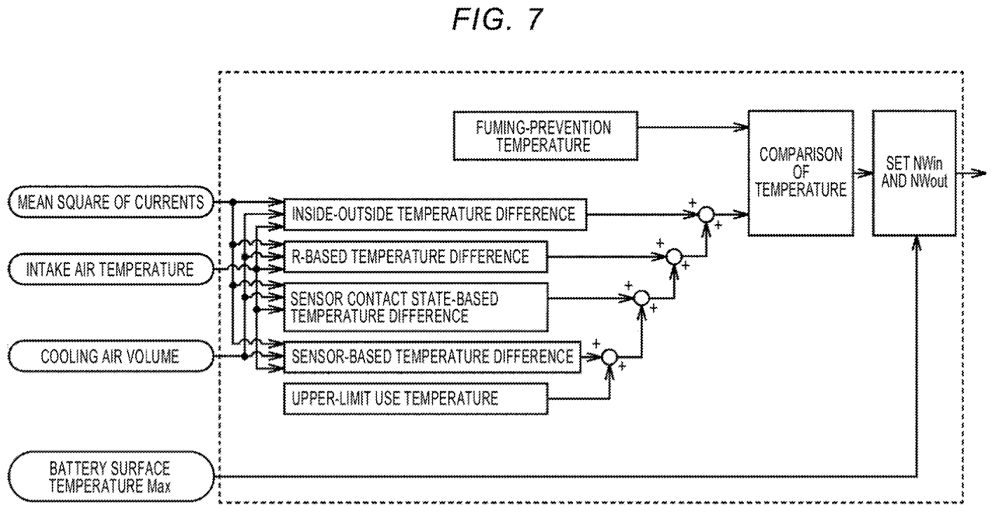

FIG. 7 is a diagram illustrating the NWin/NWout calculating process. As illustrated in FIG. 7, the ECU 300 sequentially adds an inside-outside temperature difference, an R-based temperature difference, a sensor contact state-based temperature difference, and a sensor-based temperature difference to an upper-limit use temperature of the battery pack 100 based on the mean square value of the currents B, the intake air temperature, and the cooling air volume and estimates an internal maximum temperature (hereinafter referred to as an estimated maximum temperature) of the battery pack 100.

The inside-outside temperature difference represents a temperature difference between the surface temperature and the internal temperature of the battery pack 100. The R-based temperature difference represents a temperature difference in the battery pack 100 based on a difference in internal resistance between the parallel battery blocks. The sensor contact state-based temperature difference represents a maximum value in deviation between the actual surface temperature of the battery pack 100 and the detected temperature of the temperature detecting unit 230 based on a contact state between the temperature detecting unit 230 and the surface of the battery pack 100. The sensor-based temperature difference represents a temperature difference based on a difference in detection characteristics between a plurality of temperature sensors when the temperature detecting unit 230 includes the plurality of temperature sensors.

The ECU 300 calculates the above-mentioned various temperature differences, for example, using the mean square value of the currents IB, the intake air temperature, the cooling air volume, and a predetermined map corresponding to various temperature differences. The predetermined map corresponding to various temperature differences is a map indicating relationships between the measure square value of the currents IB, the intake air temperature, the cooling air volume, and various temperature differences and is prepared by experiment or the like. The ECU 300 can calculate various temperature differences, for example, using the predetermined map and at least the mean square value of the currents IB of the mean square value of the currents TB, the intake air temperature, and the cooling air volume.

The ECU 300 compares the estimated maximum temperature with a fuming-prevention temperature and sets the upper-limit temperature based on the result of comparison. For example, when the estimated maximum temperature is greater than the fuming-prevention temperature, the ECU 300 may set a value, which is obtained by subtracting a value (or a predetermined value) set based on the magnitude of the difference between the estimated maximum temperature and the fuming-prevention temperature from the latest calculated upper-limit temperature, as the current upper-limit temperature. Alternatively, for example, when the estimated maximum temperature is equal to or less than the fuming-prevention temperature, the ECU 300 may set a value, which is obtained by adding a value (or a predetermined value) set based on the magnitude of the difference between the estimated maximum temperature and the fuming-prevention temperature to the latest calculated upper-limit temperature, as the current upper-limit temperature.

The ECU 300 sets NWin and NWout such that the temperature TB detected by the temperature detecting unit 230 does not exceed the set upper-limit temperature. For example, the ECU 300 sets NWin and NWout based on the difference between the temperature TB detected by the temperature detecting unit 230 and the set upper-limit temperature. For example, when the temperature TB is greater than the upper-limit temperature, the ECU 300 may set NWin and NWout such that the magnitudes of NWin and NWout decrease as the magnitude of the difference between the temperature TB and the upper-limit temperature increases. When the temperature TB is less than the upper-limit temperature, the ECU 300 may set NWin and NWout such that the magnitudes of NWin and NWout increase as the magnitude of the difference between the temperature TB and the upper-limit temperature increases. Operation of ECU 300

The operation of the ECU 300 will be described below based on the above-mentioned configuration and the above-mentioned flowchart.

For example, when the vehicle 1 is operating, charging and discharging of the battery pack 100 are performed based on power which is required for the vehicle 1 at the time of traveling or at the time of regenerating braking. At this time, the charging power limit value Win and the discharging power limit value Wout of the battery pack 100 are set as follows.

That is, when the voltage VB, the currents IB, and the battery temperatures TB are acquired (S10) and the cell SOCs are estimated (S12), the parallel gain calculating process is performed (S14).

In the parallel gain calculating process, the minimum temperature TBmin and the cooling air temperature TC in the battery pack 100 are acquired (S100), and the cooling factor h is set (S102).

When the cooling factor h is set, the resistance value Rtmin of the minimum-temperature cell is calculated (S104), the mean square value IBa of the currents is calculated (S106), and the offset temperature TBoffset1 is calculated based on the calculated mean square value IBa (S108).

Then, a temperature which is calculated by adding the offset temperature TBoffset1 to the temperature of the minimum-temperature cell is set as the temperature of the maximum-temperature cell, and the resistance value Rtmax of the maximum-temperature cell is calculated (S110).

The temperature index Ftmax and the temperature index Ftmin are calculated using the calculated Rtmax and the calculated Rtmin (S112 and S114), and the evaluation function ΔF is calculated (S116).

The parallel gain Para_Gain is calculated based on the calculated evaluation function ΔF and the temperature TBmin (S118).

Then, the IWin calculating process is performed S(12), and IWin is set using the calculated parallel gain Para_Gain. That is, Ilim is calculated and Itag is calculated by adding Itag_offset to the calculated Ilim. When the current IB is less than Itag, the charging power limit value IWin is set such that the current IB is not less than Ilim.

After the IWin calculating process has been performed, the DWin/DWout calculating process is performed (S18), and DWin and DWout are set using the calculated parallel gain Para_Gain. That is, DWin_pow/DWout_pow is set based on the charging/discharging intensity index D_pow, and DWin_dam/DWout_dam is set based on the positive-negative-electrode salt concentration unevenness index D_dam. Then, one having the smaller absolute value of DWin_pow and DWin_dam is set as DWin, and one having the smaller absolute value of DWout_pow and DWout_dam is set as DWout.

After the DWin/DWout calculating process has been performed, the NWin/NWout calculating process is performed (S20), and the mean square value is calculated using the parallel gain Para_Gain′ which is obtained by multiplying the parallel gain Para_Gain by the inter-cell resistance ratio Rr. The upper-limit temperature is set based on the calculated mean square value, the intake air temperature, and the cooling air volume. NWin and NWout are set such that the set upper-limit temperature is not exceeded.

One having the smallest absolute value out of IWin, DWin, and NWin is set as the limit value Win, and one having the smallest absolute value out of DWout and NWout is set as the limit value Wout (S22).

Accordingly, for example, the charging power at the time of regenerative braking of the vehicle 1 or the like is controlled such that it does not exceed the limit value Win, and the discharging power at the time of traveling of the vehicle 1 or the like is controlled such that it does not exceed the limit value Wout.

As described above, with the charging and discharging control device for a battery pack according to this embodiment, it is possible to set the charging power limit value Win and the discharging power limit value Wout in consideration of the maximum current out of currents flowing in a plurality of cells which is connected in parallel. Accordingly, by controlling charging and discharging of the battery pack 100 such that the limit value Win or Wout is not exceeded, it is possible to curb occurrence of an abnormality in the battery pack 100 and to appropriately protect the battery pack 100. Accordingly, it is possible to provide a charging and discharging control device for a battery pack and a charging and discharging control method for a battery pack that appropriately protect the battery pack including a plurality of batteries which is connected in parallel.

At the time of charging of the battery pack 100, since the charging power limit value IWin is set such that the magnitude of the current flowing in each cell does not exceed Ilim, it is possible to prevent metallic lithium from being extracted in the negative electrode of the cell.

Since the charging/discharging intensity index D_pow and the positive-negative-electrode salt concentration unevenness index D_dam indicating a degree of deterioration are calculated using the parallel gain Para_Gain, appropriate limit values DWin and DWout can be set based on the charging/discharging intensity index D_pow or the positive-negative-electrode salt concentration unevenness index D_dam. Accordingly, it is possible to curb so-called high-rate deterioration.

In addition, since the mean square value of the currents is calculated using the parallel gain Para_Gain′ which is calculated by multiplying the parallel gain Para_Gain by the inter-cell resistance ratio Rr, it is possible to accurately calculate a value in consideration of a deviation of the mean square value of the currents correlated with the amount of heat emitted. Accordingly, the charging power limit value NWin and the discharging power limit value NWout can be set such that the temperature of the battery pack 100 does not exceed the upper-limit temperature which is set using the mean square value, and the battery pack 100 can be prevented from being overheated, thereby appropriately protecting the battery pack 100.

Modified examples will be described below. In the above-mentioned embodiment, the vehicle 1 is described as an electric vehicle, but the vehicle 1 is not particularly limited to an electric vehicle as long as it is a vehicle in which at least a driving rotary electric motor and a power storage device giving and taking electric power to and from the driving rotary electric motor are mounted. The vehicle 1 may be a hybrid vehicle in which a driving electric motor and an engine are mounted (which includes a plug-in hybrid vehicle).

In the above-mentioned embodiment, the vehicle 1 employs a configuration in which a single motor generator is mounted, but the vehicle 1 may employ a configuration in which a plurality of motor generators is mounted.

In the above-mentioned embodiment, the mean square value is calculated using the parallel gain Para_Gain′ and NWin/NWout is calculated using the calculated mean square value, but a high-temperature abnormality determining process may be performed by the ECU 300 in order to prevent the battery pack 100 from being overheated in addition to calculation of NWin/NWout.

The high-temperature abnormality determining process includes processes of calculating the mean square value of the currents using the parallel gain Para_Gain′ and determining that the battery pack 100 is overheated when the calculated mean square value is greater than a threshold value. In the high-temperature abnormality determining process, it may be determined that the battery pack 100 is overheated when the battery temperature is higher than a value obtained by adding a predetermined margin to the upper-limit temperature and the battery temperature is increasing as well as when the mean square value is greater than the threshold value.

According to this configuration, since a value can be accurately calculated in consideration of a deviation of the mean square value of the currents correlated with the amount of heat emitted, it is possible to accurately determine whether the battery pack 100 is overheated.

In the above-mentioned embodiment, both the limit value Win and the limit value Wout are set, but at least one of the limit value Win and the limit value Wout may be set. As for DWin/DWout and NWin/NWout, at least one thereof may also be set in the same way.

All or some of the above-mentioned modified examples may be combined for implementation. It should be noted that the above-disclosed embodiment is exemplary in all respects and is not restrictive. The scope of the disclosure is represented by the appended claims, not by the above description, and includes all modifications within the meanings and scope equivalent to the claims.

What is claimed is:

1. A charging and discharging control device that controls charging and discharging of a battery pack including a plurality of battery elements which is connected in parallel, the charging and discharging control device for a battery pack comprising:
an estimation unit configured to estimate a current ratio of an average value of currents flowing in the plurality of battery elements to a maximum current with a largest magnitude out of the currents flowing in the plurality of battery elements based on a temperature deviation between the plurality of battery elements which are connected in parallel;
a setting unit configured to set at least one of a charging power limit value and a discharging power limit value of the battery pack using the estimated current ratio; and
a control unit configured to control charging and discharging of the battery pack such that the set limit value is not exceeded.

2. The charging and discharging control device for a battery pack according to claim 1, wherein each battery element includes a lithium-ion secondary battery, and
wherein the setting unit is configured to set an upper limit value of a charging current at which metallic lithium is not extracted in a negative electrode of at least one battery element out of the plurality of battery elements using the current ratio at the time of charging of the battery pack and to set the charging power limit value such that the magnitude of a current flowing in the battery element does not exceed the set upper limit value.

3. The charging and discharging control device for a battery pack according to claim 1, wherein each battery element includes a lithium-ion secondary battery, and
wherein the setting unit is configured to calculate a charging/discharging intensity of at least one battery element out of the plurality of battery elements and a degree of deterioration based on a bias of a salt concentration between positive and negative electrodes of the battery element using the current ratio and to set at least one of the charging power limit value and the discharging power limit value using at least one of the calculated charging/discharging intensity and the calculated degree of deterioration.

4. A charging and discharging control device that controls charging and discharging of a battery pack in which a plurality of parallel battery blocks including a plurality of battery elements which is connected in parallel is connected in series, the charging and discharging control device for a battery pack comprising:
an estimation unit configured to estimate a current ratio of an average value of currents flowing in the plurality of battery elements to a maximum current with a largest magnitude out of the currents flowing in the plurality of battery elements based on a temperature deviation between the plurality of battery elements which is connected in parallel and a resistance ratio between a first combined resistance value of an internal resistor of a first block out of the plurality of parallel battery blocks and a second combined resistance value of an internal resistor of a second block;
a setting unit configured to set at least one of a charging power limit value and a discharging power limit value of the battery pack using the estimated current ratio; and
a control unit configured to control charging and discharging of the battery pack such that the set limit value is not exceeded.

5. The charging and discharging control device for a battery pack according to claim 4, wherein the setting unit is configured to calculate a mean square value of a current flowing in the battery pack using the estimated current ratio, to set an upper limit value of a temperature of the battery pack using the calculated mean square value, and to set at least one of the charging power limit value and the discharging power limit value such that the temperature of the battery pack does not exceed the upper limit value.

6. The charging and discharging control device for a battery pack according to claim 4, further comprising a determination unit configured to calculate a mean square value of a current flowing in the battery pack using the estimated current ratio and to determine that the battery pack is overheated when the calculated mean square value is greater than a threshold value.

7. A charging and discharging control method of controlling charging and discharging of a battery pack including a plurality of battery elements which is connected in parallel, the charging and discharging control method comprising:
estimating a current ratio of an average value of currents flowing in the plurality of battery elements to a maximum current with a largest magnitude out of the currents flowing in the plurality of battery elements based on a temperature deviation between the plurality of battery elements which are connected in parallel;
setting at least one of a charging power limit value and a discharging power limit value of the battery pack using the estimated current ratio; and
controlling charging and discharging of the battery pack such that the set limit value is not exceeded.

8. A charging and discharging control method of controlling charging and discharging of a battery pack in which a plurality of parallel battery blocks including a plurality of battery elements which is connected in parallel is connected in series, the charging and discharging control method comprising:
estimating a current ratio of an average value of currents flowing in the plurality of battery elements to a maximum current with a largest magnitude out of the currents flowing in the plurality of battery elements based on a temperature deviation between the plurality of battery elements which is connected in parallel and a resistance ratio between a first combined resistance value of an internal resistor of a first block out of the plurality of parallel battery blocks and a second combined resistance value of an internal resistor of a second block;
setting at least one of a charging power limit value and a discharging power limit value of the battery pack using the estimated current ratio; and
controlling charging and discharging of the battery pack such that the set limit value is not exceeded.
